(19) United States
(12) Patent Application Publication
(10) Pub. No.: US 2016/0264849 A1
(43) Pub. Date: Sep. 15, 2016

(54) Hydrofluoric Based Invert Emulsions for Shale Stimulation

(71) Applicant: HALLIBURTON ENERGY SERVICES, INC., Houston, TX (US)

(72) Inventors: Humberto Almeida Oliveira, The Woodlands, TX (US); Weiming Li, Katy, TX (US)

(73) Assignee: Halliburton Energy Services, Inc., Houston, TX (US)

(21) Appl. No.: 14/760,679

(22) PCT Filed: Jan. 13, 2014
(86) PCT No.: PCT/US2014/011298

§ 371 Date: Jul. 13, 2015

(51) Int. Cl. C09K 8/64; E21B 43/26; E21B 43/267; C09K 8/72

(52) U.S. Cl. CPC C09K 8/64; C09K 8/72; E21B 43/26; E21B 43/267; E21B 41/02

(57) ABSTRACT

A treatment fluid for use in a combined acidizing and proppant fracturing treatment, the treatment fluid comprising: (A) an emulsion comprising: (i) a continuous oil phase; (ii) an internal aqueous phase comprising: (a) water; (b) a source of hydrofluoric acid; and (c) a source of acid other than hydrofluoric acid; and (iii) an emulsifier; and (B) a proppant. A method of fracturing a treatment zone of a well, the method comprising the steps of: (I) forming a treatment fluid; and (II) introducing the treatment fluid into the zone at a rate and pressure greater than the fracture gradient of the zone.

### FIELD

The present disclosure is related to the field of producing crude oil or natural gas from subterranean formations. More specifically, the present disclosure generally relates to methods for stimulating oil or gas production from a well.

### BACKGROUND

Maximum Conductivity Stimulation (MSC) was proposed more than three decades ago. The purpose of MCS is to sequentially treat a formation with both acidizing and proppant fracturing to maximize fracture conductivity. More recently, field applications based on MCS have started to show increased production, in some cases the MCS showing in the range of about 2-fold to about 10-fold increase producing increase in some wells. These applications typically consist of two-step treatment in the same treatment zone. For sandstone formations, an acidizing fracturing fluid is pumped first followed by a proppant-carrying fracturing fluid.

For carbonate formations, a proppant carrying fracturing fluid is pumped first then an acidizing fluid. In carbonate formations, this is usually below the fracture gradient.

Another powerful, more recent stimulation technique—Simultaneous Acid and Proppant Fracturing (SAPF)—consists of a simultaneous acidizing and fracturing treatment. The acid is pumped downhole simultaneously with the proppant load and serves as the proppant carrier fluid.

Shale formations have different compositions and characteristics and are typically treated in different ways than sandstone and carbonate formations. Shale may be defined as organic rich, fine grained sedimentary rock containing a minimum of 0.5% total organic carbon 9TOC) with a mean size of less than 0.0625 mm (0.0025 in). Shale may include laminated and fissile siltstones and claystones. Shale can be identified as gas or oil shale by organic matter, i.e., kerogen or maceral types.

Shale formations typically require use of hydrofluoric acid (HF) in place of at least a portion of the hydrochloric acid (HCl) used in previous treatments. HF systems (HF/HCl/organic acid combinations) historically have been used to acidize sandstone formations and most recently shale formations. Organic acid options for sandstone and shale acid treatments typically include: glycolic, formic, acetic, and citric acid.

### BRIEF DESCRIPTION OF THE DRAWINGS

The accompanying drawings, which are included to provide a further understanding of the disclosure and are incorporated in and constitute a part of this specification, illustrate preferred embodiments of the disclosure and together with the detailed description serve to explain the principles of the disclosure. In the drawings:

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

### DETAILED DESCRIPTION OF THE PREFERRED EMBODIMENTS

Systems and methods are described for hydrofluoric acid (HF) acidizing compositions. In particular, to systems and methods for acidizing non-carbonate formations, particularly shale formations. The examples described herein relate to HF based compositions used with shale formations for illustrative purposes only. It is understood that the description herein can refer to any suitable acidizing compositions and use with any non-carbonate formations. In particular, the systems and methods may be used wherever use of HF for acidizing treatments is desirable.

Embodiments may be utilized to provide emulsified HF for any acidizing treatment, including combined acidizing and proppant treatments.

HF should never be pumped alone when used to treat sandstone or shale formations. It is usually combined with HCl or an organic acid or combination of both. Organic acid totally or partially replaces HCl when the shale or sandstone formation contains minerals that are sensitive to HCl. HCl or organic acids are used in combination with HF to remove carbonates that are present both in sandstone and shale formations. The reaction of HF with carbonates is not desirable because it generates precipitates that can plug the pores of the formation or decrease the formation's permeability.

Embodiments of the present invention may emulsify an HF—HCl, HF-organic acid system, or and HF—HCl-organic acid system. Through emulsification a hydrocarbon phase will surround or “encapsulate” the acid droplets.

The benefits of emulsifying an HF—HCl system, an HF-organic acid system, or an HF—HCl-organic acid system, for shale stimulation may include:

1) Making the HF acid system retarded and able to deeply penetrate and stimulate the formation. Emulsified acids are retarded because the mobility of the acid droplets inside the hydrocarbon phase is limited and consequently the acid reaction rate is limited as well.

2) Reducing the water content of the fluid that is pumped into the shale formation as shales are sensitive to water. In an emulsified acid system, the hydrocarbon external phase may be approximately 30% by volume and the acid internal phase is approximately 70% by volume.

3) Hydrofluoric based invert emulsion are naturally viscous systems that can carry proppant and perform a dual stimulation treatment (Simultaneous Acid and Proppant Fracturing—SAPF) in shale or sandstone. The viscosity of hydrofluoric based invert emulsion can be enhanced by the addition of small concentrations of oil soluble polymers in the oil external phase. The oil soluble polymers may also enhance the elasticity of the invert emulsion. Viscosity and elasticity are properties that typically determine how efficient a fluid carries proppant.

Hydraulic fracturing has produced a flood of new oil production in North Dakota and Texas. But so far, that hasn't happened in California. Companies including Chevron have been trying to wrest oil from the state's vast Monterey Shale formation, with limited results.

Shale may be defined as organic rich, fine grained sedimentary rocks containing a minimum of 0.5% total organic carbon (TOC) with a mean size of less than 0.0625 mm (0.0025 in). Shale may include laminated and fissile siltstones and claystones. Shale can be identified as gas or oil shale by their organic matter (i.e. kerogen or maceral types).

Hydrofluoric based invert emulsions (HF acid in combination with HCl, or organic acids, or both HCl and organic acid, as internal phase) may be provided for shale stimulation. Embodiments may include the following:
Hydrofluoric based invert emulsion for shale fracturing, and
Hydrofluoric based invert emulsion for shale matrix acidizing, and
Hydrofluoric base invert emulsion for shale simultaneous acid and proppant fracturing (SAPF).

HF systems (HF/HCl/organic acid combination) historically have been used do acidize sandstone formations and most recently shale. Both HF and HCl have high reaction rates with silica and carbonate, respectively. Emulsifying HF systems may create a stimulation fluid not only for shale and sandstone stimulation, but also other formations with complex minerology (unconventional reservoirs), such as dirty carbonate and dirty sandstone.

Since shale-gas formations have ultra-low permeability, emulsified fluids can be used to reduce the damage/residue caused by polymer-based fracturing fluids. Surface-reactive fluids can increase hydrocarbon production from shale, even when the shale has no detectable carbonate content. The reactive fluids can increase the accessibility of microporosity and/or natural fractures. Reduction of surface-treating pressure may also be reduced by alleviation of high process zone stress in the shale formation.

Emulsifying HF systems may provide the following benefits:
Reduced impact, such as clay swelling, on water sensitive shale formations;
Natural self-diverting system for better diversion across treatment intervals with different permeability;
Reduced corrosion rates on metal parts since the acid is the internal phase of emulsion;
Retarded reaction with deep matrix penetration;
Much less, or none, residue left on formation compared to polymer based fracturing fluids for low permeability formations;
Emulsions being viscous fluids have good proppant transport properties; and
Internal reactive (acid) phase of the emulsion increases access to microporosity and/or natural fractures.

### DEFINITIONS AND USAGES

General Interpretation

The words or terms used herein have their plain, ordinary meaning in the field of this disclosure, except to the extent explicitly and clearly defined in this disclosure or unless the specific context otherwise requires a different meaning.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed. As used herein, the words “consisting essentially of,” and all grammatical variations thereof are intended to limit the scope of a claim to the specified materials or steps and those that do not materially affect the basic and novel characteristic(s) of the claimed invention.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

Terms such as “first,” “second,” “third,” etc. may be assigned arbitrarily and are merely intended to differentiate between two or more components, parts, or steps that are otherwise similar or corresponding in nature, structure, function, or action. For example, the words “first” and “second” serve no other purpose and are not part of the name or description of the following name or descriptive terms. The mere use of the term “first” does not require that there be any “second” similar or corresponding component, part, or step. Similarly, the mere use of the word “second” does not require that there be any “first” or “third” similar or corresponding component, part, or step. Further, it is to be understood that the mere use of the term “first” does not require that the element or step be the very first in any sequence, but merely that it is at least one of the elements or steps. Similarly, the mere use of the terms “first” and “second” does not necessarily require any sequence. Accordingly, the mere use of such terms does not exclude intervening elements or steps between the “first” and “second” elements or steps, etc.

Oil and Gas Reservoirs

In the context of production from a well, “oil” and “gas” are understood to refer to crude oil and natural gas, respectively. Oil and gas are naturally occurring hydrocarbons in certain subterranean formations.

A “subterranean formation” is a body of rock that has sufficiently distinctive characteristics and is sufficiently continuous for geologists to describe, map, and name it.

A subterranean formation having a sufficient porosity and permeability to store and transmit fluids is sometimes referred to as a “reservoir.”

A subterranean formation containing oil or gas may be located under land or under the seabed off shore. Oil and gas reservoirs are typically located in the range of a few hundred feet (shallow reservoirs) to a few tens of thousands of feet (ultra-deep reservoirs) below the surface of the land or seabed.

As used herein, a subterranean formation having greater than about 50% by weight of inorganic carbonate materials is referred to as a “carbonate formation.” For matrix acidizing techniques in a carbonate formation, the carbonate formation preferably is greater than about 80% by weight of inorganic carbonate materials. For example, limestone is essentially calcium carbonate. Dolomite is essentially a combination of calcium carbonate and magnesium carbonate, wherein at least 50% of the cations are magnesium.

As used herein, a subterranean formation having greater than about 50% by weight of inorganic siliceous materials (for example, sandstone) is referred to as a “sandstone formation.”

Well Servicing and Fluids

To produce oil or gas from a reservoir, a well is drilled into a subterranean formation, which may be the reservoir or adjacent to the reservoir.

Well services are designed to facilitate or enhance the production of desirable fluids such as oil or gas from or through a subterranean formation. A well service usually involves introducing a fluid into a well.

For example, a treatment for fluid-loss control can be used during any of drilling, completion, and intervention operations. During completion or intervention, stimulation is a type of treatment performed to enhance or restore the productivity of oil and gas from a well. Stimulation treatments fall into two main groups: hydraulic fracturing and matrix treatments. Fracturing treatments are performed above the fracture pressure of the subterranean formation to create or extend a highly permeable flow path between the formation and the wellbore. Matrix treatments are performed below the fracture pressure of the formation.

A “well” includes a wellhead and at least one wellbore from the wellhead penetrating the earth. The “wellhead” is the surface termination of a wellbore, which surface may be on land or on a seabed.

A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well or any other tubulars in the well. The “borehole” usually refers to the inside wellbore wall, that is, the rock surface or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

A wellbore can be used as a production or injection wellbore. A production wellbore is used to produce hydrocarbons from the reservoir. An injection wellbore is used to inject a fluid, for example, liquid water or steam, to drive oil or gas to a production wellbore.

As used herein, introducing “into a well” means introducing at least into and through the wellhead. According to various techniques known in the art, tubulars, equipment, tools, or fluids can be directed from the wellhead into any desired portion of the wellbore.

As used herein, the word “tubular” means any kind of structural body in the general form of a tube. Tubulars can be of any suitable body material, but in the oilfield they are most commonly of steel. Examples of tubulars in oil wells include, but are not limited to, a drill pipe, a casing, a tubing string, a line pipe, and a transportation pipe.

As used herein, a “fluid” broadly refers to any fluid adapted to be introduced into a well for any purpose. A fluid can be, for example, a drilling fluid, a setting composition, a treatment fluid, or a spacer fluid. If a fluid is to be used in a relatively small volume, for example less than about 100 barrels (about 4,200 US gallons or about 16 m³), it is sometimes referred to as a wash, dump, slug, or pill.

As used herein, the word “treatment” refers to any treatment for changing a condition of a portion of a wellbore or a subterranean formation adjacent a wellbore; however, the word “treatment” does not necessarily imply any particular treatment purpose. A treatment usually involves introducing a fluid for the treatment, in which case it may be referred to as a treatment fluid, into a well. As used herein, a “treatment fluid” is a fluid used in a treatment. The word “treatment” in the term “treatment fluid” does not necessarily imply any particular treatment or action by the fluid.

In the context of a well or wellbore, a “portion” or “interval” refers to any downhole portion or interval along the length of a wellbore.

A “zone” refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a fluid is directed to flow from the wellbore. As used herein, “into a treatment zone” means into and through the wellhead and, additionally, through the wellbore and into the treatment zone.

As used herein, a “downhole” fluid (or gel) is an in-situ fluid in a well, which may be the same as a fluid at the time it is introduced, or a fluid mixed with another fluid downhole, or a fluid in which chemical reactions are occurring or have occurred in-situ downhole.

Generally, the greater the depth of the formation, the higher the static temperature and pressure of the formation. Initially, the static pressure equals the initial pressure in the formation before production. After production begins, the static pressure approaches the average reservoir pressure.

Deviated wells are wellbores inclined at various angles to the vertical.

Complex wells include deviated wellbores in high-temperature or high-pressure downhole conditions.

A “design” refers to the estimate or measure of one or more parameters planned or expected for a particular fluid or stage of a well service or treatment. For example, a fluid can be designed to have components that provide a minimum density or viscosity for at least a specified time under expected downhole conditions. A well service may include design parameters such as fluid volume to be pumped, required pumping time for a treatment, or the shear conditions of the pumping.

The term “design temperature” refers to an estimate or measurement of the actual temperature at the downhole environment during the time of a treatment. For example, the design temperature for a well treatment takes into account not only the bottom hole static temperature (“BHST”), but also the effect of the temperature of the fluid on the BHST during treatment. The design temperature for a fluid is sometimes referred to as the bottom hole circulation temperature (“BHCT”). Because fluids may be considerably cooler than BHST, the difference between the two temperatures can be quite large. Ultimately, if left undisturbed a subterranean formation will return to the BHST.

Phases and Physical States

As used herein, “phase” is used to refer to a substance having a chemical composition and physical state that is distinguishable from an adjacent phase of a substance having a different chemical composition or a different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulates

As used herein, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers up to a large drop on the scale of a few millimeters. A particle of a substance in a gas state is a single atom or molecule that is separated from other atoms or molecules such that intermolecular attractions have relatively little effect on their respective motions.

As used herein, particulate or particulate material refers to matter in the physical form of distinct particles in a solid or liquid state (which means such an association of a few atoms or molecules). As used herein, a particulate is a grouping of particles having similar chemical composition and particle size ranges anywhere in the range of about 0.5 micrometer (500 nm), for example, microscopic clay particles, to about 3 millimeters, for example, large grains of sand.

A particulate can be of solid or liquid particles. As used herein, however, unless the context otherwise requires, particulate refers to a solid particulate.

It should be understood that the terms “particle” and “particulate,” includes all shapes of particles including substantially rounded, spherical, oblong, ellipsoid, rod-like, fiber, polyhedral (such as cubic materials), etc., and mixtures thereof. For example, the term “particulate” as used herein is intended to include solid particles having the physical shape of platelets, shavings, flakes, ribbons, rods, strips, spheroids, toroids, pellets, tablets or any other physical shape.

One way to measure the approximate particle size distribution of a solid particulate is with graded screens. A solid particulate material will pass through some specific mesh (that is, have a maximum size; larger pieces will not fit through this mesh) but will be retained by some specific tighter mesh (that is, a minimum size; pieces smaller than this will pass through the mesh). This type of description establishes a range of particle sizes. A “+” before the mesh size indicates the particles are retained by the sieve, while a “−” before the mesh size indicates the particles pass through the sieve. For example, −70/+140 means that 90% or more of the particles will have mesh sizes between the two values.

Particulate materials are sometimes described by a single mesh size, for example, 100 U.S. Standard mesh. If not otherwise stated, a reference to a single particle size means about the mid-point of the industry-accepted mesh size range for the particulate.

Dispersions

A dispersion is a system in which particles of a substance of one chemical composition and physical state are dispersed in another substance of a different chemical composition or physical state. In addition, phases can be nested. If a substance has more than one phase, the most external phase is referred to as the continuous phase of the substance as a whole, regardless of the number of different internal phases or nested phases.

A dispersion can be classified in different ways, including, for example, based on the size of the dispersed particles, the uniformity or lack of uniformity of the dispersion, and, if a fluid, by whether or not precipitation occurs.

A dispersion is considered to be homogeneous if the dispersed particles are dissolved in solution or the particles are less than about 1 nanometer in size. Even if not dissolved, a dispersion is considered to be homogeneous if the dispersed particles are less than about 1 nanometer in size.

A dispersion is considered to be heterogeneous if the dispersed particles are not dissolved and are greater than about 1 nanometer in size. (For reference, the diameter of a molecule of toluene is about 1 nm and a molecule of water is about 0.3 nm).

Heterogeneous dispersions can have gas, liquid, or solid as an external phase. For example, in a case where the dispersed-phase particles are liquid in an external phase that is another liquid, this kind of heterogeneous dispersion is more particularly referred to as an emulsion. A solid dispersed phase in a continuous liquid phase is referred to as a sol, suspension, or slurry, partly depending on the size of the dispersed solid particulate.

Solubility

A substance is considered to be “soluble” in a liquid if at least 10 grams of the substance can be dissolved in one liter of the liquid when tested at 77° F. and 1 atmosphere pressure for 2 hours, considered to be “insoluble” if less than 1 gram per liter, and considered to be “sparingly soluble” for intermediate solubility values.

As will be appreciated by a person of skill in the art, the hydratability, dispersibility, or solubility of a substance in water can be dependent on the salinity, pH, or other substances in the water. Accordingly, the salinity, pH, and additive selection of the water can be modified to facilitate the hydratability, dispersibility, or solubility of a substance in aqueous solution. To the extent not specified, the hydratability, dispersibility, or solubility of a substance in water is determined in deionized water, at neutral pH, and without any other additives.

The “source” of a chemical species in a solution or in a fluid composition can be a material or substance that is itself the chemical species, or that makes the chemical species chemically available immediately, or it can be a material or substance that gradually or later releases the chemical species to become chemically available in the solution or the fluid.

Fluids

A fluid can be a homogeneous or heterogeneous. In general, a fluid is an amorphous substance that is or has a continuous phase of particles that are smaller than about 1 micrometer that tends to flow and to conform to the outline of its container.

Every fluid inherently has at least a continuous phase. A fluid can have more than one phase. The continuous phase of a treatment fluid is a liquid under Standard Laboratory Conditions. For example, a fluid can be in the form of a suspension (larger solid particles dispersed in a liquid phase), a sol (smaller solid particles dispersed in a liquid phase), an emulsion (liquid particles dispersed in another liquid phase), or a foam (a gas phase dispersed in a liquid phase).

Apparent Viscosity of a Fluid

Viscosity is a measure of the resistance of a fluid to flow. In everyday terms, viscosity is “thickness” or “internal friction.” Therefore, pure water is “thin,” having a relatively low viscosity whereas honey is “thick,” having a relatively higher viscosity. Put simply, the less viscous the fluid is, the greater its ease of movement (fluidity). More precisely, viscosity is defined as the ratio of shear stress to shear rate.

A Newtonian fluid (named after Isaac Newton) is a fluid for which stress versus strain rate curve is linear and passes through the origin. The constant of proportionality is known as the viscosity. Examples of Newtonian fluids include water and most gases. Newton's law of viscosity is an approximation that holds for some substances but not others.

Non-Newtonian fluids exhibit a more complicated relationship between shear stress and velocity gradient (that is, shear rate) than simple linearity. Therefore, there exist a number of forms of non-Newtonian fluids. Shear thickening fluids have an apparent viscosity that increases with increasing the rate of shear. Shear thinning fluids have a viscosity that decreases with increasing rate of shear. Thixotropic fluids become less viscous over time at a constant shear rate. Rheopectic fluids become more viscous over time at a constant shear rate. A Bingham plastic is a material that behaves as a solid at low stresses but flows as a viscous fluid at high yield stresses.

Most fluids are non-Newtonian fluids. Accordingly, the apparent viscosity of a fluid applies only under a particular set of conditions including shear stress versus shear rate, which must be specified or understood from the context. As used herein, a reference to viscosity is actually a reference to an apparent viscosity. Apparent viscosity is commonly expressed in units of mPa·s or centipoise (cP), which are equivalent.

Like other physical properties, the viscosity of a Newtonian fluid or the apparent viscosity of a non-Newtonian fluid may be highly dependent on the physical conditions, primarily temperature and pressure.

Gels and Deformation

The physical state of a gel is formed by a network of interconnected molecules, such as a crosslinked polymer or a network of micelles. The network gives a gel phase its structure and an apparent yield point. At the molecular level, a gel is a dispersion in which both the network of molecules is continuous and the liquid is continuous. A gel is sometimes considered as a single phase.

Technically, a “gel” is a semi-solid, jelly-like physical state or phase that can have properties ranging from soft and weak to hard and tough. Shearing stresses below a certain finite value fail to produce permanent deformation. The minimum shear stress which will produce permanent deformation is referred to as the shear strength or gel strength of the gel.

In the oil and gas industry, however, the term “gel” may be used to refer to any fluid having a viscosity-increasing agent, regardless of whether it is a viscous fluid or meets the technical definition for the physical state of a gel. A “base gel” is a term used in the field for a fluid that includes a viscosity-increasing agent, such as guar, but that excludes crosslinking agents. Typically, a base gel is mixed with another fluid containing a crosslinker, wherein the mixture is adapted to form a crosslinked gel. Similarly, a “crosslinked gel” may refer to a substance having a viscosity-increasing agent that is crosslinked, regardless of whether it is a viscous fluid or meets the technical definition for the physical state of a gel.

As used herein, a substance referred to as a “gel” is subsumed by the concept of “fluid” if it is a pumpable fluid.

Viscosity and Gel Measurements

There are numerous ways of measuring and modeling viscous properties, and new developments continue to be made. The methods depend on the type of fluid for which viscosity is being measured. A typical method for quality assurance or quality control (QA/QC) purposes uses a couette device, such as a FANN™ Model 35 or 50 viscometer or a CHANDLER™ 5550 HPHT viscometer. Such a viscometer measures viscosity as a function of time, temperature, and shear rate. The viscosity-measuring instrument can be calibrated using standard viscosity silicone oils or other standard viscosity fluids.

Due to the geometry of most common viscosity-measuring devices, however, solid particulate, especially if larger than silt (larger than 74 micron), would interfere with the measurement on some types of measuring devices. Therefore, the viscosity of a fluid containing such solid particulate is usually inferred and estimated by measuring the viscosity of a test fluid that is similar to the fracturing fluid without any proppant or gravel that would otherwise be included. However, as suspended particles (which can be solid, gel, liquid, or gaseous bubbles) usually affect the viscosity of a fluid, the actual viscosity of a suspension is usually somewhat different from that of the continuous phase.

In general, a FANN™ Model 35 viscometer can be used for viscosity measurements of less than about 30 mPa·s (cP). In addition, the Model 35 does not have temperature and pressure controls, so it is used for fluids at ambient conditions (that is, Standard Laboratory Conditions). Except to the extent otherwise specified, the apparent viscosity of a fluid having a viscosity of less than about 30 cP (excluding any suspended solid particulate larger than silt) is measured with a FANN™ Model 35 type viscometer with a bob and cup geometry using an R1 rotor, B1 bob, and F1 torsion spring at a shear rate of 511 sec⁻¹ (300 rpm) and at a temperature of 77° F. (25° C.) and a pressure of 1 atmosphere.

A substance is considered to be a fluid if it has an apparent viscosity less than 5,000 mPa·s (cP) (independent of any gel characteristic). For reference, the viscosity of pure water is about 1 mPa·s (cP).

As used herein, for the purposes of proppant fracturing a fluid is considered to be “viscous” if it has an apparent viscosity of 10 mPa·s (cP) or higher. The viscosity of a viscous fluid is considered to break or be broken if the viscosity is greatly reduced. Preferably, although not necessarily for all applications depending on how high the initial viscosity of the fluid, the viscous fluid breaks to a viscosity of less than 50% of the viscosity of the maximum viscosity or less than 5 mPa·s (cP).

Historically, to be considered to be suitable for use as a carrier fluid for a proppant for conventional reservoirs or applications such as gravel packing, it has been believed that a crosslinked gel needs to exhibit sufficient viscoelastic properties, in particular relatively high viscosities (for example, at least about 300 mPa·s (cP) at a shear rate of 100 sec−1).

Permeability

Permeability refers to how easily fluids can flow through a material. For example, if the permeability is high, then fluids will flow more easily and more quickly through the material. If the permeability is low, then fluids will flow less easily and more slowly through the material.

General Measurement

Unless otherwise specified or unless the context otherwise clearly requires, any ratio or percentage means by weight.

Unless otherwise specified or unless the context otherwise clearly requires, the phrase “by weight of the water” means the weight of the water of an aqueous phase of the fluid without the weight of any viscosity-increasing agent, dissolved salt, suspended particulate, or other materials or additives that may be present in the water.

If there is any difference between U.S. or Imperial units, U.S. units are intended. For example, “GPT” or “gal/Mgal” means U.S. gallons per thousand U.S. gallons and “ppt” means pounds per thousand U.S. gallons.

Unless otherwise specified, mesh sizes are in U.S. Standard Mesh.

The micrometer (μm) may sometimes be referred to herein as a micron.

Converted to SI units, 1 darcy is equivalent to 9.869233×10⁻¹³ m² or 0.9869233 (μm)². This conversion is usually approximated as 1 (μm)².

The conversion between pound per gallon (lb/gal or ppg) and kilogram per cubic meter (kg/m³) is: 1 lb/gal=(0.4536 kg/lb)×(gal/0.003785 m³)=120 kg/m³.

The conversion between pound per thousand gallons (lb/Mgal) and kilogram per cubic meter (kg/m³) is: 1 lb/Mgal=(0.4536 kg/lb)×(Mgal/3.785 m³)=0.12 kg/m³.

### General Approach

Embodiments described herein may provide a hydrofluoric-based invert emulsion where hydrofluoric acid (HF) is used in combination with hydrochloric acid (HCl) and/or organic acid as an internal phase and oil as an external phase.

An exemplary formulation of invert emulsion may include oil water (volume) ratios (OWR) from approximately 20:80 to approximately 40:60, more preferably approximately 30:70. These ranges may provide improved acid invert emulsion stability. If the hydrocarbon phase is significantly higher than approximately 30%-40% by volume, a layer of hydrocarbon may be observed on top of the emulsion after mixing, showing an excess of hydrocarbon. If the acid internal phase is higher than approximately 70%-80% by volume it is likely there will be no emulsion.

Exemplary ranges of acid concentrations for the internal reactive phase are given below in Table 1:

TABLE 1

| Acid Type | Concentration Range (wt %) |
|---|---|
| HF | 1-3 |
| HCl | 0-15** (the range starts from zero because |
| | someone may choose not to use HCl - It will |
| | be 15 wt % when only HCl is used in |
| | conjunction with HF) |
| Glycolic Acid* | 0-15** (the range starts from zero because |
| | someone may choose not to use Glycolic Acid - |
| | It will be 15 wt % when only Glycolic acid is |
| | used in conjunction with HF) |
| Acetic Acid* | 0-15** (the range starts from zero because |
| | someone may choose not to use Acetic Acid = |
| | It will be 15 wt % when only acetic acid is |
| | used in conjunction with HF) |
| Formic Acid* | 0-15** (the range starts from zero because |
| | someone may choose not to use Formic Acid - |
| | It will be 15 wt % when only formic acid is |
| | used in conjunction with HF) |
| Citric Acid* | 0-15** (the range starts from zero because |
| | someone may choose not to use citric Acid - It |
| | will be 15 wt % when only citric acid is used in |
| | conjunction with HF) |
| Combined HCl with | 3-15 *** (This range cannot start from Zero |
| organic acid (glycolic, | because if I am using HF it has to be pumped |
| acetic, formic and/or | together with some other acid: HCl or organic. |
| citric) | |

*An organic acid, such as glycolic acid or other organic acids, may be used as a total or partial replacement for HCl in HCl sensitive clays or other formations.
**The range starts from zero because it is possible to elect not to use this acid. The range will be approximately 15 wt % when only this acid is used in conjunction with HF.
*** The total combined concentration (wt %) for the acid used in conjunction with HF (HCl alone, organic acid alone or HCl combined with organic acid) may vary from approximately 3 to 15 wt %. For example, if HCl is mixed with glycolic acid, the combined concentration of HCl and glycolic may vary from approximately 3 to 15 wt %

As noted in Table 1, concentrations of acetic, formic, glycolic or citric acid may vary from approximately 0% to approximately 15%, more preferably approximately 9% to approximately 10%. Depending on the shale minerology, the acid concentrations may vary. The wt % concentration ratio of hydrofluoric acid to other acids may vary from approximately 1 wt % HF:15 wt % other acid (HCl and/or organic acid) to approximately 3 wt % HF:3 wt % other acid (HCl and/or organic acid). Therefore, the HF concentration may vary from approximately 1 wt % to approximately 3 wt % and the HCl and/or organic acid concentration that is pumped in conjunction with the HF may vary from approximately 3 wt % to approximately 15 wt %.

For some shale formations with high carbonate concentration, such as greater than approximately 5%, HF system may not be used or pre-flush with HCl or organic acid may be performed. In certain embodiments, HF acid may not be included in the pre-flush stage. An HCl or organic acid pre-flush can be emulsified or not and the concentration can vary from approximately 5 wt % to approximately 15 wt %. The wt % ratios (wt % HF:wt % HCl or the wt % HF:wt % HCl+wt % Organic acid or the wt % HF:wt % organic acid) may change depending on the mineralogy of the formation. One example of % wt ratio would be approximately 3 wt % HF:approximately 12 wt % HF. The preferred values for typical shale formations may be the same or very close to the ratios for sandstone formations. In certain embodiments, a single treatment fluid may be used in a simultaneous acid and proppant fracturing (“SAPF”) treatment. The single fluid can perform both acid and proppant fracturing simultaneously for maximum formation stimulation.

An emulsified source of an acid may act as both a retarded acid fluid and as a carrier fluid for a proppant used in fracturing of a zone. In general, the treatment fluid may include a water-in-oil emulsion, wherein the internal aqueous phase comprises a source of an acid. The emulsion provides a fluid for the purpose of acid fracturing. The emulsion provides a retarded acid system that can create wormhole penetration into the formation while minimizing formation softening and fluid leak-off. The water-in-oil emulsion is also selected for suspending a proppant for proppant fracturing. The dual purpose fluid simultaneously creates acid wormhole penetration into the matrix of a formation while providing transport proppant. The retarded acid fluid allows time of placing the proppant while increasing the permeability of the formation and preferably forming wormholes. Non-emulsified acid systems are usually fast reacting and increase the permeability and fluid leak off, making it difficult to place the proppant inside the fracture. By pumping a single fluid with both the acid and proppant simultaneously, current SAPF technology using two separate fluids for these purposes is improved to minimize leak-off or proppant over-displacement problems.

A treatment fluid can be formed on location without major equipment modifications.

Furthermore, compared to aqueous acids or polymer-viscosified aqueous acidizing fluids, an emulsified acidizing fluid can reduce formation softening compared to acid-external fluids systems because the water-in-oil emulsion slows the contact of the acid with the formation, thereby slowing the acid reacting with the formation so that the fluid can penetrate more deeply into the formation to create better wormhole structures. An invert acid will react with the formation more slowly and not immediately increase the formation permeability.

Furthermore, compared to polymer-viscosified aqueous acidizing fluids, a treatment fluid herein can leave little or no polymer residue, which causes less formation damage compare to existing gelled acid systems.

Preferably, the emulsion is selected for having good proppant transport and displacement characteristics. Preferably, the rheological properties and stability of the emulsion are adapted to suspend the proppant for at least 10 minutes of pumping time, and more preferably at least about 30 minutes to allow for pumping time from the wellhead down to a desired portion of a well.

In addition, an emulsion herein can be formulated, if desired, to be stable for long periods of time at surface conditions, even in hot weather, before mixing with proppant or before use in a well.

Simultaneous acid and proppant fracturing (SAPF) increases the effectiveness of a reservoir stimulation by taking the advantages of both acid wormhole penetration and proppant fracturing. The benefits of the single-fluid for use in a SAPF treatment can include, for example, one or more of the following: (a) reduced operation cost and time by the use of a single treatment fluid for two purposes in the SAPF treatment; (b) minimizing leak-off and proppant over-displacement by in a treatment by including the use of a single fluid for simultaneous acid and proppant fracturing; (c) minimizing formation softening compared to using an unretarded acid fluid; (d) minimizing formation damage compared to using treatment fluids viscosified with a water-soluble polymer; or (e) maximizing reservoir recovery by dual acid and fracturing stimulation.

Treatment fluids and methods are contemplated to have particular benefits for application in SAPF treatments for complex gas reservoirs.

Certain embodiments may provide a single fluid adapted for simultaneously acidizing and proppant fracturing of a zone. It should be understood, however, that such a treatment fluid can be used alone or in combination with one or more other types of treatment fluids in a fracturing job, as may be designed by an engineer for a fracturing operation in a zone. For example, in addition to treating the zone with a treatment fluid herein, a fracturing job can optionally include, for example, one or more of the following additional treatments fluids, in any practical sequence: a pad fluid (for example, a viscous fluid or crosslinked gel) to initiate or create the fracture geometry, a diverting fluid, and fluid-loss control fluid. More than one of each of such treatment fluids, including one or more treatment fluids herein, can be used in various sequences or trains of treatment fluids as part of a fracturing operation in a zone.

### Hydraulic Fracturing

Hydraulic fracturing, commonly referred to simply as fracturing, is a common stimulation treatment. The purpose of a hydraulic fracturing treatment is to provide an improved flow path for oil or gas to flow from the hydrocarbon-bearing formation to the wellbore. In addition, a fracturing treatment can facilitate the flow of injected treatment fluids from the well into the formation. A treatment fluid adapted for this purpose is sometimes referred to as a fracturing fluid. The fracturing fluid is pumped at a sufficiently high flow rate and pressure into the wellbore and into the subterranean formation to create or enhance one or more fractures in the subterranean formation. Creating a fracture means making a new fracture in the formation. Enhancing a fracture means enlarging a pre-existing fracture in the formation.

A frac pump is used for hydraulic fracturing. A frac pump is a high-pressure, high-volume pump. Typically, a frac pump is a positive-displacement reciprocating pump. The structure of such a pump is resistant to the effects of pumping abrasive fluids, and the pump is constructed of materials that are resistant to the effects of pumping corrosive fluids. Abrasive fluids are suspensions of hard, solid particulates, such as sand. Corrosive fluids include, for example, acids. The fracturing fluid may be pumped down into the wellbore at high rates and pressures, for example, at a flow rate in excess of 50 barrels per minute (2,100 U.S. gallons per minute) at a pressure in excess of 5,000 pounds per square inch (“psi”). The pump rate and pressure of the fracturing fluid may be even higher, for example, flow rates in excess of 100 barrels per minute and pressures in excess of 10,000 psi are often encountered.

The formation or extension of a fracture in hydraulic fracturing may initially occur suddenly. When this happens, the fracturing fluid suddenly has a fluid flow path through the fracture to flow more rapidly away from the wellbore. As soon as the fracture is created or enhanced, the sudden increase in the flow of fluid away from the well reduces the pressure in the well. Thus, the creation or enhancement of a fracture in the formation may be indicated by a sudden drop in fluid pressure, which can be observed at the wellhead. After initially breaking down the formation, the fracture may then propagate more slowly, at the same pressure or with little pressure increase. It can also be detected with seismic techniques.

### Proppant for Hydraulic Fracturing

A newly-created or newly-extended fracture will tend to close together after the pumping of the fracturing fluid is stopped. To prevent the fracture from closing, a material is usually placed in the fracture to keep the fracture propped open and to provide higher fluid conductivity than the matrix of the formation. A material used for this purpose is referred to as a proppant.

A proppant is in the form of a solid particulate, which can be suspended in the fracturing fluid, carried downhole, and deposited in the fracture to form a proppant pack. The proppant pack props the fracture in an open condition while allowing fluid flow through the permeability of the pack. The proppant pack in the fracture provides a higher-permeability flow path for the oil or gas to reach the wellbore compared to the permeability of the matrix of the surrounding subterranean formation. This higher-permeability flow path increases oil and gas production from the subterranean formation.

### Carrier Fluid for Proppant

A fluid can be adapted to be a carrier fluid for a particulate.

For example, a proppant used in fracturing can have a much different density than the carrier fluid. For example, sand has a specific gravity of about 2.7, whereas water has a specific gravity of 1.0 at Standard Laboratory Conditions of temperature and pressure. A proppant having a different density than water will tend to separate from water very rapidly.

A viscosity-increasing agent can be used to increase the ability of a fluid to suspend and carry a particulate material in a fluid. A viscosity-increasing agent can be used for other purposes, such as matrix diversion, conformance control, or friction reduction.

A viscosity-increasing agent is sometimes referred to in the art as a viscosifying agent, viscosifier, thickener, gelling agent, or suspending agent. In general, any of these refers to an agent that includes at least the characteristic of increasing the viscosity of a fluid in which it is dispersed or dissolved. There are several kinds of viscosity-increasing agents or techniques for increasing the viscosity of a fluid.

Treatment fluids used in high volumes, such as fracturing fluids, are usually water-based. Efficient and inexpensive viscosity-increasing agents for water include certain classes of water-soluble polymers.

Typical water-soluble polymers used in well treatments include water-soluble polysaccharides and water-soluble synthetic polymers (for example, polyacrylamide). The most common water-soluble polysaccharides employed in well treatments are guar and its derivatives.

The viscosity of a fluid at a given concentration of viscosity-increasing agent can be greatly increased by crosslinking the viscosity-increasing agent. A crosslinking agent, sometimes referred to as a crosslinker, can be used for this purpose. A crosslinker interacts with at least two polymer molecules to form a “crosslink” between them.

If crosslinked to a sufficient extent, the polysaccharide may form a gel with water. Gel formation is based on a number of factors including the particular polymer and concentration thereof, the particular crosslinker and concentration thereof, the degree of crosslinking, temperature, and a variety of other factors known to those of ordinary skill in the art.

It should be understood that merely increasing the viscosity of a fluid may only slow the settling or separation of distinct phases and does not necessarily stabilize the suspension of any particles in the fluid.

Certain viscosity-increasing agents can also increase the elastic modulus of the fluid. The elastic modulus is the measure of a substance's tendency to be deformed non-permanently when a force is applied to it. The elastic modulus of a fluid, commonly referred to as G′, is a mathematical expression and defined as the slope of a stress versus strain curve in the elastic deformation region. G′ is expressed in units of pressure, for example, Pa (Pascals) or dynes/cm². As a point of reference, the elastic modulus of water is negligible and considered to be zero.

An example of a viscosity-increasing agent that is also capable of increasing the suspending capacity of a fluid is to use a viscoelastic surfactant. As used herein, the term “viscoelastic surfactant” or “VES” refers to a surfactant that imparts or is capable of imparting viscoelastic behavior to a fluid due, at least in part, to the three-dimensional association of surfactant molecules to form viscosifying micelles. When the concentration of the viscoelastic surfactant in a viscoelastic fluid significantly exceeds a critical concentration, and in most cases in the presence of an electrolyte, surfactant molecules aggregate into species such as micelles, which can interact to form a network exhibiting elastic behavior.

### Damage to Permeability

The material for increasing the viscosity of the fluid can damage the permeability of the proppant pack or the matrix of the subterranean formation. For example, a treatment fluid can include a polymeric material that is deposited in the fracture or within the matrix.

The term “damage” as used herein regarding a formation refers to undesirable deposits in a subterranean formation that may reduce its permeability. Filtercake, scale, skin, gel residue, and hydrates are contemplated by this term.

After application of a filtercake, it may be desirable to restore permeability of the formation. If the formation permeability of the desired producing zone is not restored, production levels from the formation can be significantly lower. Any filtercake or any solid or polymer filtration into the matrix of the zone resulting from a fluid-loss control treatment must be removed to restore the formation's permeability, preferably to at least its original level. This is often referred to as clean up.

### Breaking Viscosity of a Treatment Fluid

After a treatment fluid is placed where desired in the well and for the desired time, the downhole fluid usually must then be removed from the wellbore or the formation.

For example, in the case of hydraulic fracturing, the fluid should be removed leaving the proppant in the fracture and without damaging the conductivity of the proppant bed. To accomplish this removal, the viscosity of the treatment fluid must be reduced to a very low viscosity, preferably near the viscosity of water, for optimal removal from the propped fracture. Similarly, when a viscosified fluid is used for gravel packing, the viscosified fluid must be removed from the gravel pack.

Reducing the viscosity of a viscosified treatment fluid is referred to as “breaking” the fluid. Chemicals used to reduce the viscosity of treatment fluids are called breakers.

Breakers for reducing viscosity must be selected to meet the needs of each situation. First, it is important to understand the general performance criteria for breaking. In reducing the viscosity of the treatment fluid to a near water-thin state, the breaker must maintain a critical balance. Premature reduction of viscosity during the pumping of a treatment fluid can jeopardize the treatment. Inadequate reduction of fluid viscosity after pumping can also reduce production if the required conductivity is not obtained. A breaker should be selected based on its performance in the temperature, pH, time, and desired viscosity profile for each specific treatment.

In fracturing, for example, the ideal viscosity versus time profile would be if a fluid maintained 100% viscosity until the fracture closed on proppant and then immediately broke to a thin fluid. Some breaking inherently occurs during the 0.5 to 4 hours required to pump most fracturing treatments. One guideline for selecting an acceptable breaker design is that at least 50% of the fluid viscosity should be maintained at the end of the pumping time. This guideline may be adjusted according to job time, desired fracture length, and required fluid viscosity at reservoir temperature.

No particular mechanism is necessarily implied by breaking or breaker regarding the viscosity of a fluid.

For example, for use a fluid viscosified with a polymeric material as the viscosity-increasing agent, a breaker can operate by cleaving the backbone of polymer by hydrolysis of acetyl group, cleavage of glycosidic bonds, oxidative/reductive cleavage, free radical breakage, or a combination of these processes. Accordingly, such a breaker can reduce the molecular weight of the polymer by cutting the long polymer chain. As the length of the polymer chain is cut, the viscosity of the fluid is reduced. In another example, a breaker may reverse a crosslinking of a viscosity-increasing agent or attack the crosslinker.

For breaking a viscoelastic fluid formed with a viscoelastic surfactant as the viscosity-increasing agent, there are two principal methods of breaking: dilution of the fluid with another fluid, such as a formation fluid, and chemical breakers, such as acids.

### Acid Fracturing

In general, the purpose of acidizing in a well is to dissolve acid-soluble materials. For example, this can help remove increase the permeability of a treatment zone. A treatment fluid including an aqueous acid solution is introduced into a subterranean formation to dissolve the acid-soluble materials. In this way, fluids such as oil or gas can more easily flow through the formation and into a wellbore. In addition, an acid treatment can facilitate the flow of injected treatment fluids from the well into the formation. This procedure enhances production by increasing the effective well radius.

Acidizing techniques can be carried out as acid fracturing procedures or matrix acidizing procedures.

In acid fracturing, an acidizing fluid is pumped into a formation at a sufficient pressure to cause fracturing of the formation and to create differential (non-uniform) etching leading to higher fracture conductivity. Depending on the formation mineralogy, the acidizing fluid can etch the fracture faces, whereby flow channels are formed when the fractures close.

The acidizing fluid can also enlarge the pore spaces in the fracture faces and in the formation.

In matrix acidizing, an acidizing fluid is injected from the well into the formation at a rate and pressure below the pressure sufficient to create a fracture in the formation.

Leak-Off Problems with Acid Fracturing

When the acid is injected above the fracture pressure of the formation being treated, the treatment is called acid fracturing or fracture acidizing. The object is to create a large fracture that serves as an improved flowpath through the rock formation. After such fractures are created, when pumping of the fracture fluid is stopped and the injection pressure drops, the fracture tends to close upon itself and little or no new flow path is left open after the treatment. Commonly, a proppant is added to the fracturing fluid so that, when the fracture closes, proppant remains in the fracture, holds the fracture faces apart, and leaves a flowpath conductive to fluids. Depending on the formation mineralogy, the acid can differentially etch the faces of the fracture, creating or exaggerating asperities, so that, when the fracture closes, the opposing faces no longer match up. Consequently they leave an open pathway for fluid flow.

A problem with this technique is that as the acid is injected it tends to react with the most reactive rock or the rock with which it first comes into contact. A desired deeper penetration into the formation may not be achieved because, among other things, the acid may be spent before it can deeply penetrate into the subterranean formation. The rate at which acidizing fluids react with reactive materials in the subterranean formation is a function of various factors including, but not limited to, acid concentration, temperature, fluid velocity, mass transfer, and the type of reactive material encountered. Whatever the rate of reaction of the acidic solution, the solution can be introduced into the formation only a certain distance before it becomes spent. To achieve optimal results, it is desirable to maintain the acidic solution in a reactive condition for as long a period as possible to maximize the degree of penetration so that the permeability enhancement produced by the acidic solution may be increased.

In addition, the acidic fluid follows the paths of least resistance, which are for example either natural fractures in the rock or areas of more permeable or more acid-soluble rock. Depending on the nature of the rock formation, this process can create long branched passageways in the fracture faces leading away from the fracture, usually near the wellbore. These highly conductive micro-channels are called “wormholes” can be desired to increase producing from a producing zone but also can be very deleterious to a subsequently-injected fracturing fluid because they tend to leak off into the wormholes rather than lengthening the desired fracture. To block the wormholes, techniques called “leak-off control” techniques have been developed. This blockage should be temporary, however, because the wormholes are preferably open to flow after the fracturing treatment; fluid production through the wormholes adds to total production.

### Corrosion Problems Using Acids in Fluids

Although acidizing a portion of a subterranean formation can be very beneficial in terms of permeability, conventional acidizing systems have significant drawbacks. Corrosion can occur anywhere in a well production system or pipeline system, including anywhere downhole in a well or in surface lines and equipment.

The expense of repairing or replacing corrosion-damaged equipment is extremely high. The corrosion problem is exacerbated by the elevated temperatures encountered in deeper formations. The increased corrosion rate of the ferrous and other metals comprising the tubular goods and other equipment results in quantities of the acidic solution being neutralized before it ever enters the subterranean formation, which can compound the deeper penetration problem discussed above. In addition, the partial neutralization of the acid from undesired corrosion reactions can result in the production of quantities of metal ions that are highly undesirable in the subterranean formation.

### Single Treatment Fluid Including Invert Emulsion

Certain embodiments may provide a single treatment fluid for use in a simultaneous acid and proppant fracturing (“SAPF”) treatment. The single fluid can perform both acid and proppant fracturing simultaneously for maximum formation stimulation.

An essential feature of the present invention is the use of an emulsified source of an acid as both a retarded acid fluid and as a carrier fluid for a proppant used in fracturing of a zone. A water-in-oil emulsified acid causes the acid to spend at much slower rate, thereby retarding the chemical reaction rate with a formation. In addition, acid internal emulsions can help separate the acid from the tubulars during pumping to the treatment zone, reducing corrosion. The proppant is placed during the acidizing fracturing, thereby avoiding proppant over-displacement.

### Invert Emulsion and Emulsifier

An emulsion is a fluid including a dispersion of immiscible liquid particles in an external liquid phase. In addition, the proportion of the external and internal phases is above the solubility of either in the other. A chemical can be included to reduce the interfacial tension between the two immiscible liquids to help with stability against coalescing of the internal liquid phase, in which case the chemical may be referred to as a surfactant or more particularly as an emulsifier or emulsifying agent.

In the context of an emulsion, a “water phase” or “aqueous phase” refers to a phase of water or an aqueous solution. An “oil phase” refers to a phase of any non-polar, organic liquid that is immiscible with water, usually an oil.

An emulsion can be an oil-in-water (o/w) type or water-in-oil (w/o) type. A water-in-oil emulsion is sometimes referred to as an invert emulsion.

It should be understood that multiple emulsions are possible. These are sometimes referred to as nested emulsions. Multiple emulsions are complex polydispersed systems where both oil-in-water and water-in-oil emulsions exist simultaneously in the fluid, wherein the oil-in-water emulsion is stabilized by a lipophilic surfactant and the water-in-oil emulsion is stabilized by a hydrophilic surfactant. These include water-in-oil-in-water (w/o/w) and oil-in-water-in-oil (o/w/o) type multiple emulsions. Even more complex polydispersed systems are possible. Multiple emulsions can be formed, for example, by dispersing a water-in-oil emulsion in water or an aqueous solution, or by dispersing an oil-in-water emulsion in oil.

A stable emulsion is an emulsion that will not cream, flocculate, or coalesce under certain conditions, including time and temperature. As used herein, the term “cream” means at least some of the droplets of a dispersed phase converge towards the surface or bottom of the emulsion (depending on the relative densities of the liquids making up the continuous and dispersed phases). The converged droplets maintain a discrete droplet form. As used herein, the term “flocculate” means at least some of the droplets of a dispersed phase combine to form small aggregates in the emulsion. As used herein, the term “coalesce” means at least some of the droplets of a dispersed phase combine to form larger drops in the emulsion.

Surfactants

Surfactants are compounds that lower the surface tension of a liquid, the interfacial tension between two liquids, or that between a liquid and a solid, or that between a liquid and a gas. Surfactants may act as detergents, wetting agents, emulsifiers, foaming agents, and dispersants.

Surfactants are usually organic compounds that are amphiphilic, meaning they contain both hydrophobic groups (“tails”) and hydrophilic groups (“heads”). Therefore, a surfactant contains both a water-insoluble (or oil soluble) portion and a water-soluble portion.

A surfactant can be or include a cationic, a zwitterionic, or a nonionic emulsifier. A surfactant package can include one or more different chemicals.

In a water phase, surfactants form aggregates, such as micelles, where the hydrophobic tails form the core of the aggregate and the hydrophilic heads are in contact with the surrounding liquid. The aggregates can be formed in various shapes such as spherical or cylindrical micelles or bilayers. The shape of the aggregation depends upon various factors such as the chemical structure of the surfactant (for example, the balance of the sizes of the hydrophobic tail and hydrophilic head), the concentration of the surfactant, nature of counter ions, ionic salt concentration, co-surfactants, solubilized components (if any), pH, and temperature.

As used herein, the term micelle includes any structure that minimizes the contact between the lyophobic (“solvent-repelling”) portion of a surfactant molecule and the solvent, for example, by aggregating the surfactant molecules into structures such as spheres, cylinders, or sheets, wherein the lyophobic portions are on the interior of the aggregate structure and the lyophilic (“solvent-attracting”) portions are on the exterior of the structure. Micelles can function, among other purposes, to stabilize emulsions, break emulsions, stabilize a foam, change the wettability of a surface, or solubilize certain materials.

HLB Balance (Griffin or Davies) of a Surfactant

The hydrophilic-lipophilic balance (“HLB”) of a surfactant is a measure of the degree to which it is hydrophilic or lipophilic, determined by calculating values for the different regions of the molecule, as described by Griffin in 1949 and 1954. Other methods have been suggested, notably in 1957 by Davies.

In general, Griffin's method for non-ionic surfactants as described in 1954 works as follows:

HLB=20*Mh/M

where Mh is the molecular mass of the hydrophilic portion of the molecule, and M is the molecular mass of the whole molecule, giving a result on a scale of 0 to 20. An HLB value of 0 corresponds to a completely lipidphilic/hydrophobic molecule, and a value of 20 corresponds to a completely hydrophilic/lypidphobic molecule. Griffin W C: “Classification of Surface-Active Agents by ‘HLB,’” Journal of the Society of Cosmetic Chemists 1 (1949): 311. Griffin W C: “Calculation of HLB Values of Non-Ionic Surfactants,” Journal of the Society of Cosmetic Chemists 5 (1954): 249.

The HLB (Griffin) value can be used to predict the surfactant properties of a molecule, where a value less than 10 indicates that the surfactant molecule is lipid soluble (and water insoluble), whereas a value greater than 10 indicates that the surfactant molecule is water soluble (and lipid insoluble).

The HLB (Griffin) value can be used to predict the uses of the molecule, for example, where: a value from about 4 to about 11 indicates a W/O (water in oil) emulsifier, and a value from about 12 to about 16 indicates O/W (oil in water) emulsifier.

In 1957, Davies suggested an extended HLB method based on calculating a value based on the chemical groups of the molecule. The advantage of this method is that it takes into account the effect of stronger and weaker hydrophilic groups. The method works as follows:

HLB=7+m*Hh−n*Hl

where m is the number of hydrophilic groups in the molecule, Hh is the respective group HLB value of the hydrophilic groups, n is the number of lipophilic groups in the molecule, and Hl is the respective group HLB value of the lipophilic groups. The specific values for the hydrophilic and hydrophobic groups are published. See, for example, Davies J T: “A quantitative kinetic theory of emulsion type, I. Physical chemistry of the emulsifying agent,” Gas/Liquid and Liquid/Liquid Interface. Proceedings of the International Congress of Surface Activity (1957): 426-438.

The HLB (Davies) model can be used for applications including emulsification, detergency, solubilization, and other applications. Typically a HLB (Davies) value will indicate the surfactant properties, where a value of about 1 to about 3 indicates anti-foaming of aqueous systems, a value of about 3 to about 7 indicates W/O emulsification, a value of about 7 to about 9 indicates wetting, a value of about 8 to about 28 indicates O/W emulsification, a value of about 11 to about 18 indicates solubilization, and a value of about 12 to about 15 indicates detergency and cleaning.

Emulsifiers

As used herein, an “emulsifier” refers to a type of surfactant that helps prevent the droplets of the dispersed phase of an emulsion from flocculating or coalescing in the emulsion.

An emulsifier or emulsifier package is preferably in a concentration of at least 1% by weight of the emulsion. More preferably, the emulsifier is in a concentration in the range of 1% to 10% by weight of the emulsion.

Emulsion for Increasing Viscosity

One approach to increasing the viscosity of a fluid is the use of an emulsion. The internal-phase droplets of an emulsion disrupt flow streamlines and require more effort to get the same flow rate. Thus, an emulsion tends to have a higher viscosity than the external phase of the emulsion would otherwise have by itself. This property of an emulsion can be used to help suspend a particulate material in an emulsion. This technique for increasing the viscosity of a liquid can be used separately or in combination with other techniques for increasing the viscosity of a fluid.

Using an emulsion, the rheology of a fluid can be modified to meet particulate suspending requirements and avoid particulate sag. One way to change the rheology is to change the size of the internal aqueous droplets by changing the shear applied during the mixing and increasing the emulsifier concentration. Higher emulsifier concentration and more shear during mixing results in smaller and more droplets that will cause to emulsion to have higher viscosity.

But viscosity alone will not make the emulsion to carry proppant. Emulsions are shear-thinning fluids. Once emulsions are in motion, the droplets tend to align and viscosity will drop quite a bit. Once viscosity drops, elasticity has to come into play to maintain the proppant in suspension.

To enhance the elasticity of an invert emulsion, an oil-soluble polymer can be added to the external phase. Adding a water-soluble polymer to the internal aqueous phase would not be expected to help in terms of enhancing proppant suspension capability; however, the use of a relative permeability modifier (“RPM”) water-soluble polymer in the internal aqueous phase of can help decrease the fluid losses to the formation.

Emulsion Stability and Breaking

Preferably, an emulsion should be stable under one or more of certain conditions commonly encountered in the storage and use of such an emulsion composition for a well treatment operation. More preferably, the dispersed liquid phase does not cream, flocculate, or coalesce when stored at ambient conditions for at least two hours. It should be understood that the dispersion can be visually examined for creaming, flocculating, or coalescing.

As used herein, to “break,” in regard to an emulsion, means to cause the creaming and coalescence of emulsified drops of the internal dispersed phase so that the internal phase separates out of the external phase. For example, breaking an emulsion can be accomplished mechanically (for example, in settlers, cyclones, or centrifuges), or via dilution, or with chemical additives to increase the surface tension of the internal droplets.

### Continuous Oil Phase

In the context of a fluid, oil is understood to refer to any kind of oil in a liquid state, whereas gas is understood to refer to a physical state of a substance, in contrast to a liquid. In this context, an oil is any substance that is liquid under Standard Laboratory Conditions, is hydrophobic, and soluble in organic solvents. Oils typically have a high carbon and hydrogen content and are non-polar substances. This general definition includes classes such as petrochemical oils, vegetable oils, and many organic solvents. All oils, even synthetic oils, can be traced back to organic sources.

The continuous oil phase of an emulsion herein can comprise an oil selected from the group consisting of: diesel oil, mineral oil, synthetic oil, enhanced mineral oil, and any combination thereof

Preferably, the oil phase of the treatment fluid does not contain anything that would adversely interact with the other components used in the fluid or with the subterranean formation.

Preferably, the oil to water ratio is anywhere in the range of about 20:80 to about 50:50, more preferably between about 20:80 and about 40:60. In certain embodiments, the oil to water ratio is anywhere in the range of about 25:75 to about 45:55.

### Internal Aqueous Phase

Water for Aqueous Phase

The aqueous phase can include freshwater or non-freshwater. Non-freshwater sources of water can include surface water ranging from brackish water to seawater, brine, returned water (sometimes referred to as flowback water) from the delivery of a fluid into a well, unused fluid, and produced water.

Preferably, the water for use in the treatment fluid does not contain anything that would adversely interact with the other components used in the fluid or with the subterranean formation. For example, in general, for water to be suitable for use in common well treatments, it should not contain one or more materials that would be particularly detrimental to the chemistry involved in such well treatments.

In addition, the water is preferably cleaned of undissolved, suspended solids (for example, silt) at least to a point that the natural permeability and the conductivity of the fracture will not be damaged. For this purpose, all the water used in a well treatment can be filtered to help reduce the concentration of suspended, undissolved solids that may be present in the water, such as silt.

Dissolved Salts or Brines

In some embodiments, the aqueous phase of the treatment fluid can comprise one or more dissolved salts or can be a brine. For example, the brine can be chosen to be compatible with the formation to be treated and should have a sufficient density to provide the appropriate degree of well control. As used herein, brine refers to water having at least 40,000 mg/L total dissolved solids.

Salts may optionally be included in the treatment fluids for many purposes. For example, salts may be added to a water source, for example, to provide a brine, and a resulting treatment fluid, having a desired density. Salts may optionally be included for reasons related to compatibility of the treatment fluid with the formation and formation fluids. To determine whether a salt may be beneficially used for compatibility purposes, a compatibility test may be performed to identify potential compatibility problems. From such tests, one of ordinary skill in the art with the benefit of this disclosure will be able to determine whether a salt should be included in a treatment fluid.

Salts can include, but are not limited to, calcium chloride, sodium chloride, magnesium chloride, potassium chloride, sodium bromide, potassium bromide, ammonium chloride, sodium formate, potassium formate, cesium formate, mixtures thereof, and the like. The concentration of a salt that should be added should be the amount necessary for formation compatibility, such as stability of clay minerals, taking into consideration the crystallization temperature of the brine, for example, the temperature at which the salt precipitates from the brine as the temperature drops.

Source of Acid and pH of Aqueous Phase

The aqueous phase includes a source of an acid. Preferably, the source of the acid does not have undesirable properties, as discussed above.

Preferably, the pH of the aqueous phase of the treatment fluid is less than about 3. More preferably, the pH of the aqueous phase is less than about 1. Most preferably, the pH of the aqueous phase is less than about zero.

Mineral acids tend to dissociate in water more easily than organic acids, to produce H⁺ ions and decrease the pH of the solution. Organic acids tend to dissociate more slowly than mineral acids and less completely.

Preferably, the source of the acid is hydrochloric acid (HCl). For acidizing of a sandstone formation, hydrofluoric acid (HF) can also be included.

### Corrosion and Inhibition

Corrosion of Metals

Corrosion of metals can occur anywhere in an oil or gas production system, such in the downhole tubulars, equipment, and tools of a well, in surface lines and equipment, or transportation pipelines and equipment.

“Corrosion” is the loss of metal due to chemical or electrochemical reactions, which could eventually destroy a structure. The corrosion rate will vary with time depending on the particular conditions to which a metal is exposed, such as the amount of water, pH, other chemicals, temperature, and pressure. Examples of common types of corrosion include, but are not limited to, the rusting of metal, the dissolution of a metal in an acidic solution, oxidation of a metal, chemical attack of a metal, electrochemical attack of a metal, and patina development on the surface of a metal.

As used herein with reference to the problem of corrosion, “acid” or “acidity” refers to a Bronsted-Lowry acid or acidity.

As mineral acids are stronger acids than organic acids, mineral acids tend to be more corrosive than organic acids. In addition, at elevated temperatures the dissociation rate increases significantly, and hence, all else being equal, an acid becomes more corrosive.

The mechanism of corrosion for both cases (mineral acids and organic acids) is expected to be same, the only difference is in the rate of corrosion. The rate of corrosion will depend upon the availability of H⁺ ion released from acid. Mineral acids dissociate completely to give more H⁺ ions as compared to organic acids.

In the range of pH 4 to 10, the corrosion rate of iron or steel is relatively independent of the pH of the solution. In this pH range, the corrosion rate is governed largely by the rate at which oxygen reacts with absorbed atomic hydrogen, thereby depolarizing the surface and allowing the reduction reaction to continue.

For acidic pH values below 4, ferrous oxide (FeO) is soluble. Thus, the oxide dissolves as it is formed rather than depositing on the metal surface to form a film. In the absence of the protective oxide film, the metal surface is in direct contact with the acid solution, and the corrosion reaction proceeds at a greater rate than it does at higher pH values. It is also observed that hydrogen is produced in acid solutions below a pH of 4, indicating that the corrosion rate no longer depends entirely on depolarization by oxygen, but on a combination of the two factors (hydrogen evolution and depolarization).

Corrosion Inhibitor

As used herein, the term “inhibit” or “inhibitor” refers to slowing down or lessening the tendency of a phenomenon (for example, corrosion) to occur or the degree to which that phenomenon occurs. The term “inhibit” or “inhibitor” does not imply any particular mechanism, or degree of inhibition.

A “corrosion inhibitor package” can include one or more different chemical corrosion inhibitors, sometimes delivered to the well site in one or more solvents to improve flowability or handlability of the corrosion inhibitor before forming a fluid.

Examples of corrosion inhibitors include acetylenic alcohols, Mannich condensation products (such as those formed by reacting an aldehyde, a carbonyl containing compound and a nitrogen containing compound), unsaturated carbonyl compounds, unsaturated ether compounds, formamide, formic acid, formates, other sources of carbonyl, iodides, terpenes, and aromatic hydrocarbons, coffee, tobacco, gelatin, cinnamaldehyde, cinnamaldehyde derivatives, acetylenic alcohols, fluorinated surfactants, quaternary derivatives of heterocyclic nitrogen bases, quaternary derivatives of halomethylated aromatic compounds, combinations of such compounds used in conjunction with iodine; quaternary ammonium compounds; and combinations thereof

According to a preferred embodiment of the invention, the corrosion inhibitor is selected from the group consisting of: a quaternary ammonium salt such as 1-(benzyl) quinolinium chloride, preferably together with an aldehyde.

In general, when included in a fluid, a corrosion inhibitor is preferably in a concentration of at least 0.1% by weight of a fluid. More preferably, the corrosion inhibitor is in a concentration in the range of 0.1% to 15% by weight of the fluid.

Corrosion Inhibitor Intensifier

A corrosion inhibitor “intensifier” is a chemical compound that itself does not inhibit corrosion, but enhances the effectiveness of a corrosion inhibitor over the effectiveness of the corrosion inhibitor without the corrosion inhibitor intensifier. For example, a corrosion inhibitor intensifier can be selected from the group consisting of: formic acid, potassium iodide, and any combination thereof

When included in a fluid, a corrosion inhibitor intensifier is preferably in a concentration of at least 0.1% by weight of the fluid. More preferably, the corrosion inhibitor intensifier is in a concentration in the range of 0.1% to 20% by weight of the fluid.

### Proppant

A particulate for use as a proppant is usually selected based on the characteristics of size range, crush strength, and solid stability in the types of fluids that are encountered or used in wells. Preferably, a proppant should not melt, dissolve, or otherwise degrade from the solid state under the downhole conditions.

The proppant is selected to be an appropriate size to prop open the fracture and bridge the fracture width expected to be created by the fracturing conditions and the fracturing fluid. If the proppant is too large, it will not easily pass into a fracture and will screenout too early. If the proppant is too small, it will not provide the fluid conductivity to enhance production. See, for example, W. J. McGuire and V. J. Sikora, “The Effect of Vertical Fractures on Well Productivity,” Trans., AIME (1960) 219, 401-403. In the case of fracturing relatively permeable or even tight-gas reservoirs, a proppant pack should provide higher permeability than the matrix of the formation. In the case of fracturing ultra-low permeable formations, such as shale formations, a proppant pack should provide for higher permeability than the naturally occurring fractures or other micro-fractures of the fracture complexity.

Appropriate sizes of particulate for use as a proppant are typically in the range from about 8 to about 100 U.S. Standard Mesh. A typical proppant is sand-sized, which geologically is defined as having a largest dimension ranging from about 0.06 millimeters up to about 2 millimeters (mm) (The next smaller particle size class below sand size is silt, which is defined as having a largest dimension ranging from less than about 0.06 mm down to about 0.004 mm.) As used herein, proppant does not mean or refer to suspended solids, silt, fines, or other types of insoluble solid particulate smaller than about 0.06 mm (about 230 U.S. Standard Mesh). Further, it does not mean or refer to particulates larger than about 3 mm (about 7 U.S. Standard Mesh).

The proppant is sufficiently strong, that is, has a sufficient compressive or crush resistance, to prop the fracture open without being deformed or crushed by the closure stress of the fracture in the subterranean formation. For example, for a proppant material that crushes under closure stress, a 20/40 mesh proppant preferably has an API crush strength of at least 4,000 psi closure stress based on 10% crush fines according to procedure API RP-56. A 12/20 mesh proppant material preferably has an API crush strength of at least 4,000 psi closure stress based on 16% crush fines according to procedure API RP-56. This performance is that of a medium crush-strength proppant, whereas a very high crush-strength proppant would have a crush-strength of about 10,000 psi. In comparison, for example, a 100-mesh proppant material for use in an ultra-low permeable formation such as shale preferably has an API crush strength of at least 5,000 psi closure stress based on 6% crush fines. The higher the closing pressure of the formation of the fracturing application, the higher the strength of proppant is needed. The closure stress depends on a number of factors known in the art, including the depth of the formation.

Further, a suitable proppant should be stable over time and not dissolve in fluids commonly encountered in a well environment. Preferably, a proppant material is selected that will not dissolve in water or crude oil.

Examples of proppant materials include, without limitation, sand, gravel, bauxite, ceramic materials, glass materials, polymer materials, wood, plant and vegetable matter, nut hulls, walnut hulls, cottonseed hulls, cured cement, fly ash, fibrous materials, composite particulates, hollow spheres or porous particulate. Mixtures of different kinds or sizes of proppant can be used as well.

In conventional reservoirs, a proppant commonly has a median size anywhere within the range of about 20 to about 100 U.S. Standard Mesh. For a synthetic proppant, it commonly has a median size anywhere within the range of about 8 to about 100 U.S. Standard Mesh.

The concentration of proppant in the treatment fluid depends on the nature of the subterranean formation. As the nature of subterranean formations differs widely, the concentration of proppant in the treatment fluid may be in the range of from about 0.03 kilograms to about 12 kilograms of proppant per liter of liquid phase (from about 0.1 lb/gal to about 25 lb/gal).

In some embodiments, resin or tackifying agent coated particulates may be suitable for use in the treatment fluids.

One common problem is that the proppant may not be sufficiently strong by itself to prop open a fracture. Another common problem is that the surface of the proppant may have an undesirable wettability characteristic for producing oil or gas from a particular subterranean formation. Another common problem is that, as the oil or gas moves through the subterranean formation, it can dislodge and carry particulate with the fluid into the wellbore. The migration of this particulate can plug pores in the formation or proppant pack, decreasing production, in addition to causing abrasive damage to wellbore pumps, tubing, and other equipment.

To help alleviate some of the common problems mentioned above, a resinous material can be coated on the proppant. The term “coated” does not imply any particular degree of coverage on the proppant particulates, which coverage can be partial or complete.

As used herein, the term “resinous material” means a material that is a viscous liquid and has a sticky or tacky characteristic when tested under Standard Laboratory Conditions. A resinous material can include a resin, a tackifying agent, and any combination thereof in any proportion. The resin can be or include a curable resin.

For example, some or all of the proppant can be coated with a curable resin. The curable resin can be allowed to cure on the proppant prior to the proppant being introduced into the well. The cured resin coating on the proppant provides a protective shell encapsulating the proppant and keeping the fine particulates in place if the proppant was crushed or provides a different wettable surface than the proppant without the coating.

A curable resin coating on the proppant can be allowed to cure after the proppant is placed in the subterranean formation for the purpose of consolidating the proppant of a proppant pack to form a “proppant matrix.” As used herein, “proppant matrix” means a closely associated group of proppant particles as a coherent mass of proppant. Typically, a cured resin consolidates the proppant pack into a hardened, permeable, coherent mass. After curing, the resin reinforces the strength of the proppant pack and reduces the flow back of proppant from the proppant pack relative to a similar proppant pack without such a cured resin coating.

A resin or curable resin can be selected from natural resins, synthetic resins, and any combination thereof in any proportion. Natural resins include, but are not limited to, shellac. Synthetic resins include, but are not limited to, epoxies, furans, phenolics, and furfuryl alcohols, and any combination thereof in any proportion. Examples of resins suitable for coating particulates are described in U.S. Pat. Nos. 6,668,926; 6,729,404; and 6,962,200. An example of a suitable commercially available resin is the “EXPEDITE” product sold by Halliburton Energy Services, Inc. of Duncan, Okla.

By way of another example, some or all of the proppant can be coated with a tackifying agent, instead of, or in addition to, a curable resin. The tackifying agent acts to consolidate and help hold together the proppant of a proppant pack to form a proppant matrix. Such a proppant matrix can be flexible rather than hard. The tackifying-agent-coated proppant in the subterranean formation tends to cause small particulates, such as fines, to stick to the outside of the proppant. This helps prevent the fines from flowing with a fluid, which could potentially clog the openings to pores.

Examples of tackifying agents include, but are not limited to, polyamides, polyesters, polyethers and polycarbamates, polycarbonates, and any combination thereof in any proportion. Examples of tackifying agents suitable for coating particulates are described in U.S. Pat. Nos. 5,853,048; 5,833,000; 5,582,249; 5,775,425; 5,787,986, 7,131,491 the relevant disclosures of which are herein incorporated by reference. An example of a suitable commercially available tackifying agent is the “SANDWEDGE” product sold by Halliburton Energy Services, Inc. of Duncan, Okla.

It is also possible treat a previously-formed proppant pack with an overflush of a curable resin or a tackifying agent to coat the proppant in the subterranean formation. If a curable resin is used in the overflush treatment, the resin is allowed to cure after coating the proppant pack. Similarly, a curable resin or tackifying agent can be introduced into a subterranean formation to help consolidate particulate naturally occurring in a poorly or a loosely consolidated formation. Treatments for controlling proppant or sand migration are sometimes referred to as sand control, and treatments for controlling the migration of fines are sometimes referred to as fines control.

### Other Fluid Additives

In certain embodiments, the treatment fluids also can optionally comprise other commonly used fluid additives, such as those selected from the group consisting of surfactants, bactericides, fluid-loss control additives, stabilizers, chelants, scale inhibitors, corrosion inhibitors, hydrate inhibitors, clay stabilizers, salt substitutes (such as trimethyl ammonium chloride), relative permeability modifiers (such as HPT-1™ commercially available from Halliburton Energy Services, Duncan, Okla.), sulfide scavengers, fibers, nanoparticles, and any combinations thereof

The emulsion can also include a freezing-point depressant. More preferably, the freezing point depressant is for the water of the continuous phase. Preferably, the freezing-point depressant is selected from the group consisting of water soluble ionic salts, alcohols, glycols, urea, and any combination thereof in any proportion.

Of course, additives should be selected for not interfering with the purpose of the fluid.

Method of Treating a Well with the Fluid

According to another embodiment of the invention, a method of treating a well, is provided, the method including the steps of: forming a treatment fluid herein; and introducing the treatment fluid into the well.

Fracturing methods can include a step of designing or determining a fracturing treatment for a treatment zone of the subterranean formation prior to performing the fracturing stage. For example, a step of designing can include: (a) determining the design temperature and design pressure; (b) determining the total designed pumping volume of the one or more fracturing fluids to be pumped into the treatment zone at a rate and pressure above the fracture pressure of the treatment zone; (c) designing a fracturing fluid, including its composition and rheological characteristics; (d) determining the size of a proppant of a proppant pack previously formed or to be formed in fractures in the treatment zone; and (e) designing the loading of any proppant in the fracturing fluid.

In certain embodiments, a method of treatment of a well may include methods for simultaneous acidizing and proppant fracturing (SAPF). The methods may include forming a treatment fluid containing (A) an emulsion including: (i) a continuous oil phase; (ii) an internal aqueous phase containing: (a) water; (b) a source of hydrofluoric acid; and (c) a source of an acid other than hydrofluoric acid; and (iii) an emulsifier; and (B) a proppant. The method may also include introducing the treatment fluid into the zone within a non-carbonate formation. Certain embodiments may include introducing the treatment fluid into the zone at a rate and pressure greater than the fracture gradient of the zone. A ratio of (b) hydrofluoric acid to (c) an acid other than hydrofluoric acid may be between approximately 1 wt %:15 wt % and 3 wt %:3 wt %. The source of an acid other than hydrofluoric acid may be hydrochloric acid, one or more organic acids, or hydrochloric acid combined with one or more organic acid. The oil to water ratio may be between approximately 20:80 and approximately 40:60. The method may also include pre-flushing with hydrochloric acid or one or more organic acids with a concentration between approximately 5 wt % and approximately 15 wt %, where a formation may include carbonate concentrations greater than approximately 5%. The pre-flush may be emulsified and may not include hydrofluoric acid. The method may include mixing the treatment fluid using mixing equipment, and introducing the treatment fluid into the zone within the non-carbonate formation using one or more pumps.

Designing a fracturing treatment usually includes determining a designed total pumping time for the treatment of the treatment zone or determining a designed total pumping volume of fracturing fluid for the treatment zone. The tail end of a fracturing treatment is the last portion of pumping time into the zone or the last portion of the volume of fracturing fluid pumped into the zone. This is usually about the last minute of total pumping time or about the last wellbore volume of a fracturing fluid to be pumped into the zone. The portion of pumping time or fracturing fluid volume that is pumped before the tail end of a fracturing stage reaches into a far-field region of the zone.

A person of skill in the art is able to plan each fracturing treatment in detail, subject to unexpected or undesired early screenout or other problems that might be encountered in fracturing a well. A person of skill in the art is able to determine the wellbore volume between the wellhead and the zone. In addition, a person of skill in the art is able to determine the time within a few seconds in which a fluid pumped into a well should take to reach a zone.

In addition to being designed in advance, the actual point at which a fracturing fluid is diverted from a zone can be determined by a person of skill in the art, including based on observed changes in well pressures or flow rates.

A fluid can be prepared at the job site, prepared at a plant or facility prior to use, or certain components of the fluid can be pre-mixed prior to use and then transported to the job site. Certain components of the fluid may be provided as a “dry mix” to be combined with fluid or other components prior to or during introducing the fluid into the well.

In certain embodiments, the preparation of a fluid can be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

Both options are possible. An emulsion herein may be adapted to be stable for days or weeks. So it can be pre-mixed ahead of time off-site or on-site. The emulsion also has the option of being mixed on the fly as it is being pumped. In offshore operations where storage capacity is very limited acid emulsions are preferably mixed on the fly. For pre-mixing the emulsion part of a treatment fluid herein, a centrifugal pump and two tanks can be employed: one tank holding the hydrocarbon phase and the other tank holding the aqueous phase. For on-the-fly mixing, an additional mixing element or device can provide sufficient shear to create the emulsion.

Often the step of delivering a fluid into a well is within a relatively short period after forming the fluid, for example, less within 30 minutes to one hour. More preferably, the step of delivering the fluid is immediately after the step of forming the fluid, which is “on the fly.”

It should be understood that the step of delivering a fluid into a well can advantageously include the use of one or more fluid pumps.

The step of introducing comprises introducing the treatment fluid under conditions at least sufficient for fracturing a treatment zone. For example, the fluid is introduced into the treatment zone at a rate and pressure that are at least sufficient to fracture the zone. In general, a fracturing treatment or stage preferably includes pumping the one or more fracturing fluids into a treatment zone at a rate and pressure above the fracture pressure of the treatment zone.

Any of the fracturing methods herein can include a step of monitoring to help determine the end of a fracturing stage. The end of a fracturing stage is the end of pumping into a treatment zone, which can be due to screenout at or near the wellbore or other mechanical or chemical diversion of fluid to a different treatment zone.

One technique for monitoring is measuring the pressure in the wellbore along the treatment zone. Another technique includes a step of determining microseismic activity near the zone to confirm an increase in fracture complexity in the treatment zone.

Seismic data is used in many scientific fields to monitor underground events in subterranean rock formations. In order to investigate these underground events, micro-earthquakes, also known as microseisms, are detected and monitored. Like earthquakes, microseisms emit elastic waves—compressional (“p-waves”) and shear (“s-waves”), but they occur at much higher frequencies than those of earthquakes and generally fall within the acoustic frequency range of 200 Hz to more than 2000 Hz. Standard microseismic analysis techniques locate the microseismic activity caused by fluid injection or hydraulic fracturing.

Microseismic detection is often utilized in conjunction with hydraulic fracturing or water flooding techniques to map created fractures. A hydraulic fracture induces an increase in the formation stress proportional to the net fracturing pressure as well as an increase in pore pressure due to fracturing fluid leak off Large tensile stresses are formed ahead of the crack tip, which creates large amounts of shear stress. Both mechanisms, pore pressure increase and formation stress increase, affect the stability of planes of weakness (such as natural fractures and bedding planes) surrounding the hydraulic fracture and cause them to undergo shear slippage. It is these shear slippages that are analogous to small earthquakes along faults.

Microseisms are detected with multiple receivers (transducers) deployed on a wireline array in one or more offset well bores. With the receivers deployed in several wells, the microseism locations can be triangulated as is done in earthquake detection. Triangulation is accomplished by determining the arrival times of the various p- and s-waves, and using formation velocities to find the best-fit location of the microseisms. However, multiple offset wells are not usually available. With only a single nearby offset observation well, a multi-level vertical array of receivers is used to locate the microseisms. Data is then transferred to the surface for subsequent processing to yield a map of the hydraulic fracture network geometry.

Multiple or staged fracturing involves fracturing two or more different zones of a wellbore in succession. Staged hydraulic fracturing operations are commonly performed from horizontal wellbores placed in shale gas reservoirs. In the context of staged fracturing, diversion techniques are used to divert a fracturing fluid from one treatment zone to a different treatment zone. Diversion techniques fall into two main categories: mechanical diversion and chemical diversion. Mechanical diversion includes the use of mechanical devices, such as ball sealers or packers, to isolate one zone from another and divert a treatment fluid to the desired zone. Chemical diversion includes the use of chemicals to divert a treatment fluid from entering a zone in favor of entering a different zone.

After the step of introducing a fluid, the method can include a step of allowing time for the acid of the treatment fluid to spend in the formation. In addition, the method can include allowing time for the emulsion to break in the formation, if the emulsion is adapted to break after the spending of the acid, separating the two phases substantially separating such that the emulsion is broken.

Preferably, the step of flowing back is within about 7 days of the step of introducing the treatment fluid. More preferably, the step of flowing back is within about 24 hours of the step of introducing. In another embodiment, the step of flowing back is within 16 hours of the step of introducing.

Preferably, any acid in the fluid is substantially spent in the formation before flowing back the downhole fluid from the well. Any excess acid could be neutralized at the surface before disposal.

Preferably, after any such well treatment, a step of producing hydrocarbon from the subterranean formation is the desirable objective.

### CONCLUSION

Therefore, the present invention is well adapted to attain the ends and advantages mentioned as well as those that are inherent therein.

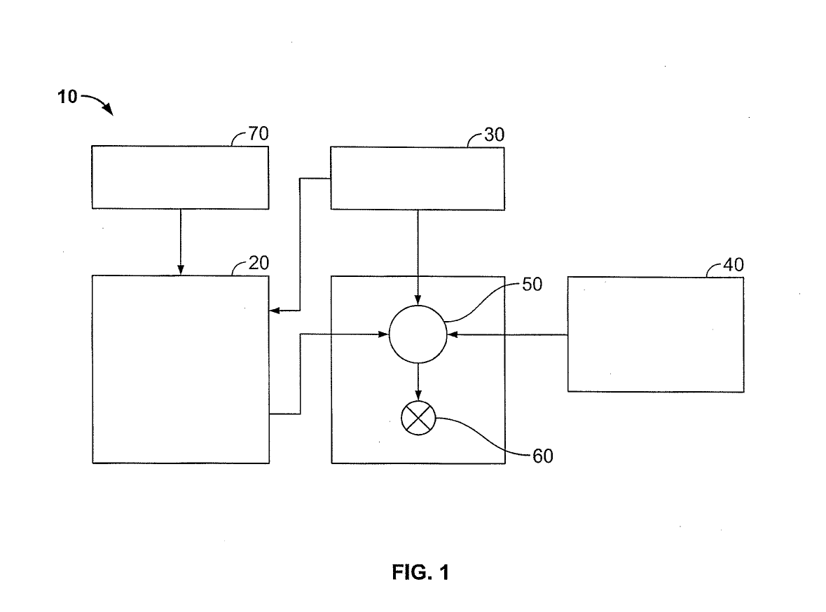

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant for combination with the fracturing fluid. The system may also include additive source 70 that provides one or more additives (e.g., gelling agents, weighting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 can source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppants at other times, and combinations of those components at yet other times.

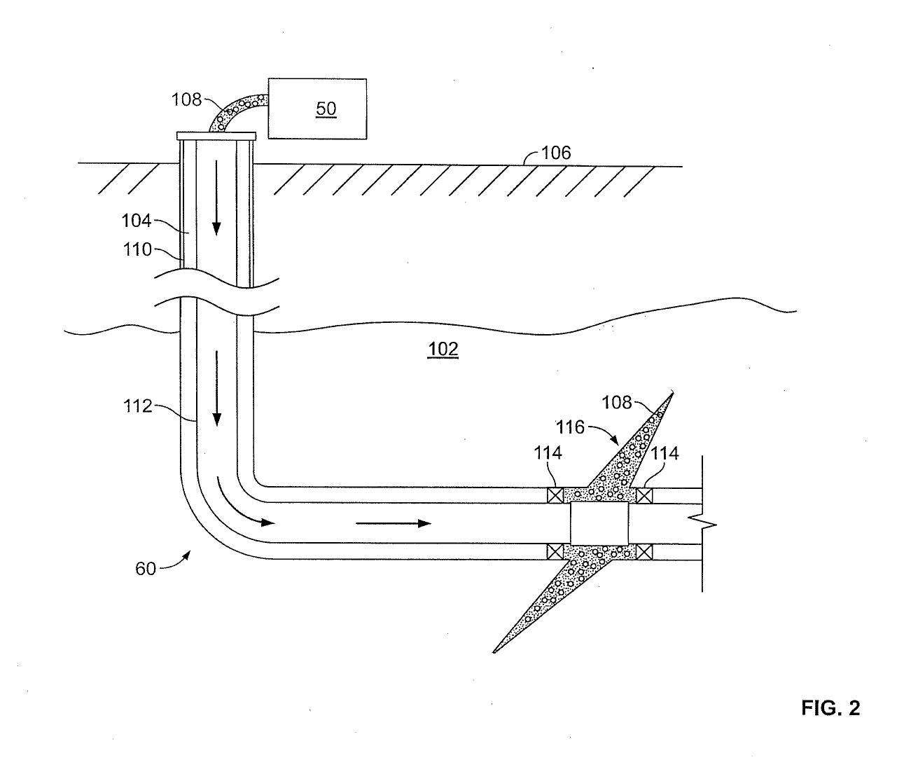

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro jetting and/or other tools.

The well is shown with a work string 112 depending from the surface 106 into the well bore 104. The pump and blender system 50 is coupled a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope of the present invention.

The various elements or steps according to the disclosed elements or steps can be combined advantageously or practiced together in various combinations or sub-combinations of elements or sequences of steps to increase the efficiency and benefits that can be obtained from the invention.

It will be appreciated that one or more of the above embodiments may be combined with one or more of the other embodiments, unless explicitly stated otherwise.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

Although the foregoing description is directed to the preferred embodiments of the disclosure, it is noted that other variations and modifications will be apparent to those skilled in the art, and may be made without departing from the spirit or scope of the disclosure. Moreover, features described in connection with one embodiment of the disclosure may be used in conjunction with other embodiments, even if not explicitly stated above.

What is claimed is:

1. An invert emulsion comprising:
(i) a continuous oil phase;
(ii) an internal aqueous phase comprising:
(a) water;
(b) a source of hydrofluoric acid; and
(c) a source of an acid other than hydrofluoric acid; and
(iii) an emulsifier.

2. The invert emulsion of claim 1, further comprising a proppant.

3. The invert emulsion of claim 1, wherein the wt % concentration ratio of (b) hydrofluoric acid to (c) an acid other than hydrofluoric acid is between approximately 1 wt %:15 wt % and 3 wt %:3 wt %.

4. The invert emulsion of claim 1, wherein the source of an acid other than hydrofluoric acid is hydrochloric acid.

5. The invert emulsion of claim 1, wherein the source of an acid other than hydrofluoric acid is an organic acid selected from the group consisting of: acetic, citric, formic, glycolic acid, and combinations thereof.

6. The invert emulsion of claim 1, wherein the hydrofluoric acid has a wt % concentration from approximately 1 wt % to approximately 3 wt %.

7. The invert emulsion of claim 1, wherein the acid other than hydrofluoric acid has a wt % concentration from approximately 3% to approximately 15%.

8. The invert emulsion of claim 1, wherein the source of an acid other than hydrofluoric acid is hydrochloric acid alone, or organic acid alone, or hydrochloric acid combined with organic acid at a combined wt % concentration from approximately 3 wt % to approximately 15 wt %.

9. The invert emulsion of claim 1, wherein the oil to water ratio is between approximately 20:80 and approximately 40:60.

10. A treatment fluid comprising:
(A) an emulsion comprising:
(i) a continuous oil phase;
(ii) an internal aqueous phase comprising:
(a) water;
(b) a source of hydrofluoric acid; and
(c) a source of an acid other than hydrofluoric acid; and
(iii) an emulsifier; and
(B) a proppant.

11. The treatment fluid of claim 10, wherein the source of an acid other than hydrofluoric acid is hydrochloric acid, one or more organic acids, or hydrochloric acid combined with one or more organic acids.

12. The treatment fluid of claim 10, wherein the source of an acid other than hydrofluoric acid is an organic acid selected from the group consisting of: acetic acid, citric acid, formic acid, glycolic acid, and combinations thereof.

13. The treatment fluid of claim 10, wherein the oil to water ratio is between approximately 20:80 and approximately 40:60.

14. A method of fracturing a treatment zone of a well, the method comprising the steps of:
(I) forming a treatment fluid comprising:
(A) an emulsion comprising:
(i) a continuous oil phase;
(ii) an internal aqueous phase comprising:
(a) water;
(b) a source of hydrofluoric acid; and
(c) a source of an acid other than hydrofluoric acid; and
(iii) an emulsifier; and
(B) a proppant; and
(II) introducing the treatment fluid into the zone within a non-carbonate formation at a rate and pressure greater than the fracture gradient of the zone.

15. The method according to claim 14, wherein a ratio of (b) hydrofluoric acid to (c) an acid other than hydrofluoric acid is between approximately 1 wt %:15 wt % and 3 wt %:3 wt %.

16. The method according to claim 14, wherein the source of an acid other than hydrofluoric acid is hydrochloric acid, one or more organic acids, or hydrochloric acid combined with one or more organic acid.

17. The method according to claim 14, wherein the oil to water ratio is between approximately 20:80 and approximately 40:60.

18. The method according to claim 14, further comprising pre-flushing with hydrochloric acid or one or more organic acids with a concentration between approximately 5 wt % and approximately 15 wt %, where a formation comprises carbonate concentrations greater than approximately 5%.

19. The method according to claim 18, wherein the pre-flush is emulsified and does not comprise hydrofluoric acid.

20. The method of claim 14, further comprising mixing the treatment fluid using mixing equipment, and introducing the treatment fluid into the zone within the non-carbonate formation using one or more pumps.
